(19) United States
(12) Patent Application Publication
(10) Pub. No.: US 2009/0043956 A1
(43) Pub. Date: Feb. 12, 2009

(54) Mapping an input data value to a resultant data value

(76) Inventor: Simon Ford, Cambridgeshire (GB)

Correspondence Address: NIXON & VANDERHYE, PC, 901 NORTH GLEBE ROAD, 11TH FLOOR, ARLINGTON, VA, 22203, US

(21) Appl. No.: 11/918,750

(22) PCT Filed: Apr. 20, 2005
(86) PCT No.: PCT/GB2005/001494

§ 371 Date: Oct. 18, 2007

(51) Int. Cl. G06F 12/00

(52) U.S. Cl. 711/108; 711/E12.001

(57) ABSTRACT

A data processing apparatus operable to map an input data value 10 to a resultant data value 50 is disclosed, said data processing apparatus comprising: a ternary content addressable memory 20 operable to store a plurality of first data values; a data store operable 30 to store a plurality of second data values corresponding to said plurality of first data values; said ternary content addressable memory 20 comprising a data input operable to receive said input data value, said ternary content addressable memory being operable to match said input data value to a first data value and to control said data store to output a second data value corresponding to said matched first data value; said data processing apparatus further comprising exclusive combination logic operable to exclusively combine at least some bits of said output second data value with at least some bits of said input data value to produce at least some bits of said resultant data value.

The present invention relates to the field of data value mapping and in certain preferred embodiments to the field of mapping bit-fields to bit-fields.

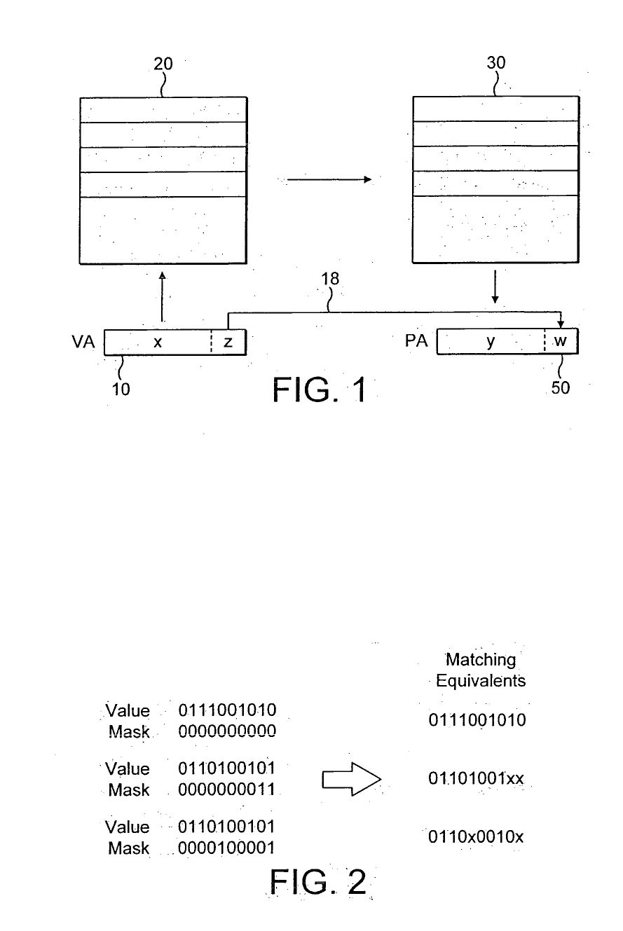

Binary content addressable memories or CAMs are known. These are circuits that can be used as standard memory cells for storing data, but unlike standard memory cells they have a “match mode” which allows data in the CAM device to be searched in parallel and compared with an input data value. This is a powerful tool and these sorts of circuits are very useful in some situations. For example, a virtual to physical address translation can be performed by using a CAM in combination with a RAM as shown in FIG. 1. An upper portion x of the virtual address 10 is looked up in the CAM 20. If a match is found, a corresponding entry is read from a RAM 30 providing the translated upper portion y of the physical address 50. The remaining lower portion z of the virtual address 10 is passed unchanged to form the lower part w of the physical address 50. This solution provides dedicated bits that are mapped and dedicated bits that are untranslated, but does not provide a flexible solution in which the bits to be mapped and those to remain unchanged can be selected as required for each data value.

Binary CAMS with modifications to allow variable masking and therefore matching are known. e.g., each CAM entry stores the match value, with additional space and circuit to specify the number of lower bits to mask out as don't care bits that therefore don't need to be matched. For example:

| value | masklength |
|---|---|
| 0111001010 | 0 |
| 0110100101 | 2 |
| 1101010010 | 2 |

giving matching equivalent to
0111001010
01101001xx
11010100xx

This could be used to vary the number of bits used to match the virtual to physical address translation. However, it is limited to masking out the lower bits, and requires modifications to the CAM structure (no longer just a standard CAM) and additional outputs to provide the mask value to merge the lower bits into the output.

Ternary CAMs are also known. They are like binary CAMS in that they are used for matching entries, but rather than matching all the input bits to an entry, they are used for matching a number of input bits to entries, that number being variable on a per entry basis. Thus, they allow comparisons to be performed in parallel, but have the additional property of allowing selection of certain bits in a data value to be compared, the others bits being specified as “don't care” bits. FIG. 2 schematically shows example data and mask values that could be stored in a ternary CAM 20 according to the prior art and the data equivalents that would provide a match to the value and mask stored. As can be seen a ternary CAM is similar to a traditional binary CAM except that with every data value there is stored further information a mask that indicates whether a particular bit is to be used in any comparison or whether it can be ignored. Thus each value stored comprises bits that are to be matched and “don't care bits”. The don't care bits can be specified in different ways. In the example shown they are specified by ones in a corresponding mask value. Thus a ternary CAM has the flexibility to select different portions of data values and only compare the bits in these portions.

As with binary CAMS a portion of the input can be hard wired to the output, but similarly to binary CAMs this does not provide a solution in which the bits to be mapped and those to remain unchanged can be selected as required for each data value. Providing outputs for the mask value to enable merging of the desired translated bits can provide this flexibility as with the binary CAM example, but again requires modifications to the CAM.

A first aspect of the present invention provides a data processing apparatus operable to map an input data value to a resultant data value, said data processing apparatus comprising: a ternary content addressable memory operable to store a plurality of first data values; a data store operable to store a plurality of second data values corresponding to said plurality of first data values; said ternary content addressable memory comprising a data input operable to receive said input data value, said ternary content addressable memory being operable to match said input data value to a first data value and to control said data store to output a second data value corresponding to said matched first data value; said data processing apparatus further comprising exclusive combination logic operable to exclusively combine at least some bits of said output second data value with at least some bits of said input data value to produce at least some bits of said resultant data value.

The present invention recognises that although a prior art ternary CAM is very flexible in allowing different portions of the input data value to be compared to the stored data value this flexibility does not translate to the selected output data value. It addresses this problem by providing exclusive combination logic to exclusively combine at least a portion of the data value output from the data store with a corresponding portion of the input data value to produce a portion of the resultant data value. This allows, by selection of appropriate exclusive combination logic and second output data values stored within the data store, portions of the input value to be mapped to a further data value and portions to be retained. Furthermore, as this mapping is dependent on the second output data value, this can vary for each stored data value, thereby providing more flexibility than a traditional ternary CAM. Thus, using known components such as a ternary CAM and data store, but combining input and output data values using exclusive combination logic an extremely flexible system can be provided at very little extra cost.

It should be noted that by ternary content addressable memory we mean any CAM having data values stored with values indicating which of the bits of the data values are to be considered in a comparison and which can be ignored.

In embodiments of the present invention said resultant data value comprises a first portion and said data store is operable to store second data values having a corresponding first portion said bit values within said corresponding first portion of said second data values being such that said exclusive combination logic is operable to output corresponding bits of said input data value as said first portion of said resultant data.

Embodiments of the present invention allow a particular portion (the so-called first portion) of the input value to be selected to be retained in a corresponding portion of the resultant data by, selection of appropriate corresponding bits of the second data value. This means that as there is a second data value corresponding to each first data value different sized portions and portions relating to different bits can be selected for each data value stored, by storing an appropriate second data value.

In embodiments of the present invention, said resultant data value comprises a second portion comprising at least one bit from a further data value and said data store is operable to store second data values having a corresponding second portion said bit values within said corresponding second portion of said second data values being such that said exclusive combination logic is operable to output said at least one bit from said further data value as said second portion of said resultant data.

Embodiments of the present invention allow a further portion (the so-called second portion) of the resultant value to be selected to correspond to a particular further data value. The size and position of this portion can be selected to be different for each second data value. This allows flexibility in the system.

Although a number of different combination logics can be used in embodiments of the invention, in preferred embodiments said exclusive combination logic comprises exclusive OR logic operable to exclusive OR said at least some bits of said input data value with corresponding bits of said second data value to produce at least some bits of said resultant data value.

Use of exclusive OR gates to combine at least some bits of the input data value with corresponding bits of the second data value is a simple yet effective way of selecting which bit from a further data value and which from the input data value should be output.

In embodiments of the invention that use exclusive OR logic said data store is operable to store second data values comprising bit values that are zeros in positions corresponding to said first portion and bit values in bit positions corresponding to said second portion that are an exclusive OR of said corresponding input data value bits and said further data value bits.

In these embodiments, the second data values have zeros in bit positions corresponding to the first portion as these exclusive ORed with the input value output the input value itself, while the second portion has the exclusive OR of the corresponding input data value bit and further data value bit as this will provide the further data value bit as an output when exclusive ORed with the input data value bit.

In some embodiments, said input data value is the same size as said resultant data value, said resultant data value consisting of said first and said second portions, while in other embodiments the resultant data value may be larger than the input data value or indeed smaller than it.

In embodiments of the invention, said data processing apparatus comprises data communication paths operable to communicate at least one of said data input value bits to at least one corresponding bit of said resultant data value without performing data processing on said value.

It may be desirable, to always output some of the input value bits as resultant bits. In this case, they can be hard wired across rather than being compared with values in the ternary CAM and then passing through the exclusive combination logic.

In some embodiments, said ternary content addressable memory further comprises a hit signal output, operable to output a hit signal when a match of said input data value and said first data value is detected.

In some cases, there may not be a match at all. Thus, it is convenient to have a hit signal to signal to the data processing apparatus when there is a match. If there is not a match the data processing apparatus may need to perform other functions such as a memory access, thus it needs some indication that a match has been detected.

In embodiments, said first data values are wider than said second data values and said exclusive combination logic is operable to combine said output second data value with corresponding at least some bits of said first data value.

Embodiments of the present invention are applicable to ternary CAMs that are wider than the data stores. In such circumstances, only a portion of the data value in the ternary CAM will be combined via the exclusive combination logic with the second data value. It should be noted that in fact not all of the second data value need be combined with a portion of the first data value but in fact it could be selected that a portion of both are combined.

In some embodiments, said second data value is wider than said first data value and said exclusive combination logic is operable to combine said first data value with corresponding at least some bits of said output second data value.

In embodiments where the data store is wider than the ternary CAM, not all of the bits of the second output data are exclusive ORed with the bits of the first data value. Rather, these additional bits are simply output as resultant bits without passing through the exclusive combination logic.

A second aspect of the present invention provides a method of processing data to map an input data value to a resultant data value, comprising the steps of: storing a plurality of first data values in a ternary content addressable memory; storing a plurality of second data values corresponding to said plurality of first data values in a data store; inputting said input data value to a data input of said ternary content addressable memory; matching said input data value to a first data value within said ternary content addressable memory; outputting a second data value from said data store corresponding to said matched first data value; exclusively combining at least some bits of said output second data value with at least some bits of said input data value to produce at least some bits of said resultant data value.

A third aspect of the present invention provides a data processing means for mapping an input data value to a resultant data value, comprising: a ternary content addressable memory means for storing a plurality of first data values; means for storing a plurality of second data values corresponding to said plurality of first data values; said ternary content addressable memory means comprising a data input operable to receive said input data value, said ternary content addressable memory means being operable to match said input data value to a first data value and to control said means for storing to output a second data value corresponding to said matched first data Value; said data processing means further comprising means for exclusively combining at least some bits of said output second data value with at least some bits of said input data value to produce at least some bits of said resultant data value.

Embodiments of the present invention will now be described, by way of example only, with reference to the accompanying drawings, in which:

FIG. 1 schematically shows a virtual to physical address mapping using a conventional binary CAM;

FIG. 2 schematically shows example data and mask values stored within a conventional ternary CAM;

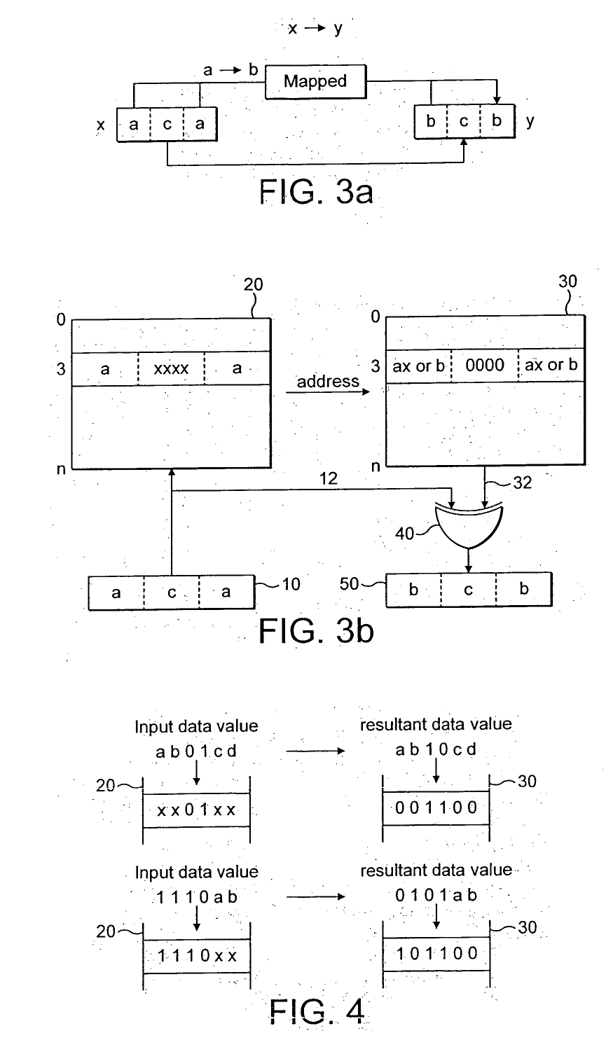

FIG. 3a schematically shows the mapping of input data value X to resultant data value Y;

FIG. 3b schematically shows the components that perform the mapping of FIG. 3a;

FIG. 4 schematically shows some input data values, desired resultant data values and their corresponding ternary CAM and RAM entries;

FIG. 5 shows a table lookaside buffer according to an embodiment of the invention; and

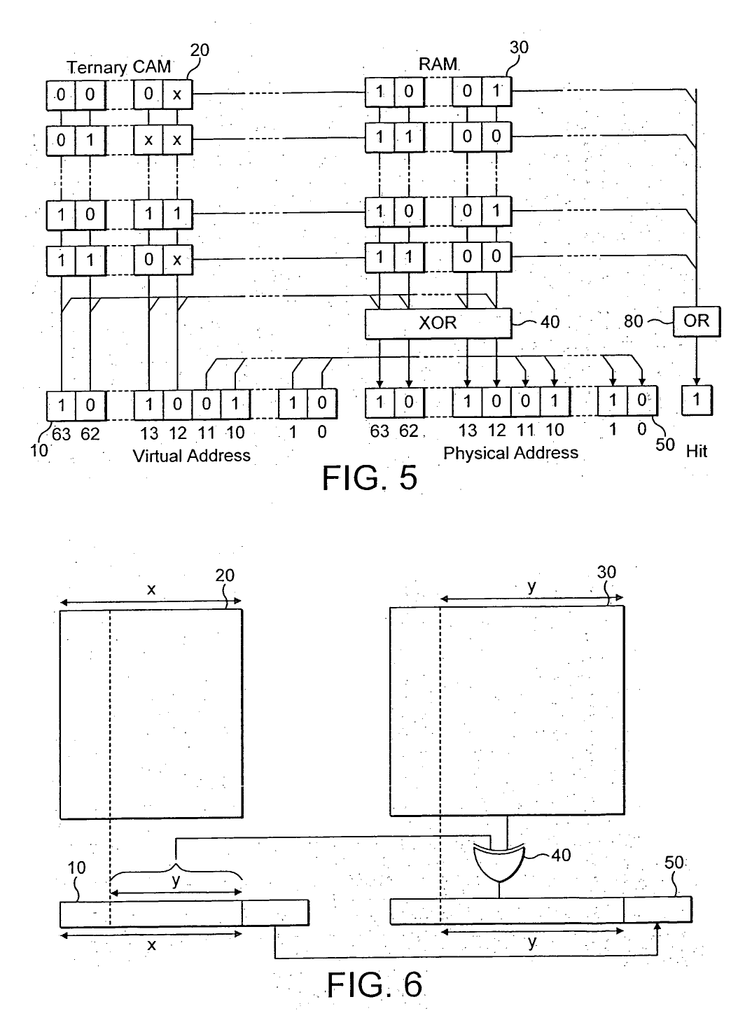

FIG. 6 shows an apparatus for mapping data values according to an embodiment of the invention.

FIG. 3a schematically shows the mapping of input data value X to resultant data value Y. Input data value X consists of different portions. In the example shown one of the portions, the middle portion in this example is to retain its value c in the output data value. The outer portions in this example a are to be mapped to a further data value b. FIG. 3B schematically shows the circuit which performs this data mapping. Input data value 10 is input into a ternary CAM 20 and is compared to the value stored within. In this case, entry 3 in the ternary CAM 20 matches the input data value 10 in that it comprises the same bit values in portion a and don't care bit values in a portion corresponding to the portion storing c. Ternary CAM 20 therefore signals this match to RAM 30 and a corresponding entry 3 in RAM 30 is output on line 32. RAM 30 is populated with data values chosen to provide the desired resultant value when exclusive ORed with the input data value. Thus, in this case the corresponding data entry 3 from the RAM 30 comprises bits in portions corresponding to portion a of the input data value which are a XOR b, while the bits corresponding to portion c of the input data value are zeros. Thus, this value is output on data line 32 and the input data value 10 is input with this value to exclusive OR logic 40 and resultant data value 50 is output. Thus, by populating the ternary CAM and RAM with appropriate data values, selected portions of each data value can be mapped to a further data value while other portions can retain their input data value.

FIG. 4 schematically shows some input data values, desired resultant data values and the ternary CAM entry and RAM entries that are required in order for the input data value to give the resultant data value. What is shown here in particular, is how this system can choose the granularity of the mapping. For example, in the first example a 6 bit input data value has 2 bits that are matched and the other 4 bits that are passed through the system to be output in their current form.

In the second example given the input data value has 2 bits that are output in the resultant data value and 4 bits that are matched.

FIG. 5 shows an embodiment of the present invention that is used as a table lookaside buffer. In this figure, ternary CAM 20 stores the portions of an address that. are to be matched with input virtual address 10. In this diagram, a portion of the virtual address corresponding to the stored portions is compared with the portions stored in the ternary CAM 20, a match indicating a location within the RAM 30. The data from this location is then output to exclusive OR logic 40 and XORed with the corresponding bits of the input data value 10 to produce the corresponding portion of the physical address 50. Further portions of the virtual address in this case the lower portions, are hard wired across as these are the same in both the virtual and physical addresses. In addition to this there is a further hit signal 80 which is produced and which indicates whether there is a match or not. In the case of there not being a match this indicates to the processing apparatus that the virtual address is not in the table lookaside buffer.

The embodiment shown in FIG. 5 is based on a standard ternary CAM structure 20 which is populated with the addresses to map from, and with x's or don't care bits in locations that the input bit is to be passed to the output bit. The number of bit-fields mapped by an entry is therefore 2^{(number of x's)}. Each RAM entry for the associated CAM entry is populated such that every bit is the XOR of the CAM entry and the desired output bit. If the CAM entry is x the RAM entry is 0. This allows an associative address translation where the number of bits passed through unmodified can be varied on a per-entry basis. This has the potential to greatly lower the number of entries required in a system where locality and therefore address granularity can vary.

Embodiments of the invention are particularly appropriate to table lookaside buffers as shown above, as they provide a choice of page granularity on a per entry basis. This provides great flexibility for the operating system or TLB loader and allows it to make efficient use of the fast hardware structure over a diverse range applications and workloads.

FIG. 6 shows a further schematic example of a data processing apparatus according to an embodiment of the present invention. In this figure, the input data 10 is mapped to resultant data 50. As can be seen ternary CAM 20 has a width of x bits, and thus, the corresponding x bits of the input data value are compared to the bits that are not “don't care” bits stored in ternary CAM 20. On a match, the corresponding entry in RAM 30 is output. A certain number of the bits from this output data value are then XORed with corresponding bits of the input data value 10 to produce a portion Y of the resultant data value. Some bits of the resultant data value 50 are output directly from the RAM 30 while other bits of the resultant data value 50 are hard wired from the input data value 10. This diagram shows the potential flexibility of the system. Not only can different portions of the input data value within the section Y be selected to be passed through to the resultant data value, but additional bits can be hard-wired directly across for all entries, and further bits can be output directly from RAM 30 to the resultant data value. Thus, some bits of the resultant data value can be directly output from the RAM, some bits can be directly hard wired across from the input data value and a selectable portion of the input data value can be passed through and a further selectable portion can be mapped via a desired mapping using the properties of the ternary CAM.

1. A data processing apparatus operable to map an input data value to a resultant data value, said data processing apparatus comprising:
a ternary content addressable memory operable to store a plurality of first data values;
a data store operable to store a plurality of second data values corresponding to said plurality of first data values;
said ternary content addressable memory comprising a data input operable to receive said input data value, said ternary content addressable memory being operable to match said input data value to a first data value and to control said data store to output a second data value corresponding to said matched first data value;
said data processing apparatus further comprising exclusive combination logic operable to exclusively combine at least some bits of said output second data value with at least some bits of said input data value to produce at least some bits of said resultant data value.

2. A data processing apparatus according to claim 1, wherein said resultant data value comprises a first portion and said data store is operable to store second data values having a corresponding first portion said bit values within said corresponding first portion of said second data values being such that said exclusive combination logic is operable to output corresponding bits of said input data value as said first portion of said resultant data.

3. A data processing apparatus according to claim 2, wherein said resultant data value comprises a second portion comprising at least one bit from a further data value and said data store is operable to store second data values having a corresponding second portion said bit values within said corresponding second portion of said second data values being such that said exclusive combination logic is operable to output said at least one bit from said further data value as said second portion of said resultant data.

4. A data processing apparatus according to claim 1, wherein said exclusive combination logic comprises exclusive OR logic operable to exclusive OR said at least some bits of said input data value with corresponding bits of said second data value to produce at least some bits of said resultant data value.

5. A data processing apparatus according to claim 4, wherein said data store is operable to store second data values comprising bit values that are zeros in positions corresponding to said first portion and bit values in bit positions corresponding to said second portion that are an exclusive OR of said corresponding input data value bits and said further data value bits.

6. A data processing apparatus according to claim 1, wherein said input data value is the same size as said resultant data value, said resultant data value consisting of said first and said second portion.

7. A data processing apparatus according to claim 1, said data processing apparatus comprising data communication paths operable to communicate at least one of said data input value bits to at least one corresponding bit of said resultant data value without performing data processing on said value.

8. A data processing apparatus according to claim 1, wherein said ternary content addressable memory further comprises a hit signal output, operable to output a hit signal when a match of said input data value and said first data value is detected.

9. A data processing apparatus according to claim 1, wherein said first data values are wider than said second data values and said exclusive combination logic is operable to combine said output second data value with corresponding at least some bits of said first data value.

10. A data processing apparatus according to claim 1, wherein said second data value is wider than said first data value and said exclusive combination logic is operable to combine said first data value with corresponding at least some bits of said output second data value.

11. A method of processing data to map an input data value to a resultant data value, comprising the steps of:
storing a plurality of first data values in a ternary content addressable memory;
storing a plurality of second data values corresponding to said plurality of first data values in a data store;
inputting said input data value to a data input of said ternary content addressable memory;
matching said input data value to a first data value within said ternary content addressable memory;
outputting a second data value from said data store corresponding to said matched first data value;
exclusively combining at least some bits of said output second data value with at least some bits of said input data value to produce at least some bits of said resultant data value.

12. A data processing means for mapping an input data value to a resultant data value, comprising:
a ternary content addressable memory means for storing a plurality of first data values;
means for storing a plurality of second data values corresponding to said plurality of first data values;
said ternary content addressable memory means comprising a data input operable to receive said input data value, said ternary content addressable memory means being operable to match said input data value to a first data value and to control said means for storing to output a second data value corresponding to said matched first data value;
said data processing means further comprising means for exclusively combining at least some bits of said output second data value with at least some bits of said input data value to produce at least some bits of said resultant data value.
